(19) United States
(12) Patent Application Publication
(10) Pub. No.: US 2026/0336303 A1
(43) Pub. Date: Oct. 29, 2026

(54) PRINTER

(71) Applicant: BROTHER KOGYO KABUSHIKI KAISHA, Nagoya (JP)

(72) Inventor: Akihiro Kawakita, Okazaki (JP)

(21) Appl. No.: 19/702,212

(22) Filed: Jun. 9, 2026

Related U.S. Application Data
(63) Continuation of application No. PCT/JP2025/000646, filed on Jan. 10, 2025.

(30) Foreign Application Priority Data
Jan. 30, 2024 (JP) 2024-011931

(51) Int. Cl. B41J 2/175; B41J 2/21; B41J 11/00; B41J 11/06; B41J 11/14; B41J 13/00; B41J 29/13

(52) U.S. Cl. CPC B41J 2/17596; B41J 2/17563; B41J 2/2103; B41J 2/2117; B41J 11/0015; B41J 11/06; B41J 11/14; B41J 13/0027; B41J 29/13

(57) ABSTRACT

A printer includes a housing, a head, an ejection device, and a treatment liquid tank. The head is disposed in the housing. The head is configured to eject ink onto a print medium. The ejection device is configured to eject a treatment liquid onto the print medium. The treatment liquid forms an undercoat for ink or an overcoat for ink. The treatment liquid tank communicates with the ejection device. The treatment liquid tank is configured to store the treatment liquid to be supplied to the ejection device. The treatment liquid tank is disposed in the housing.

### REFERENCE TO RELATED APPLICATIONS

This is a Continuation Application of International Application No. PCT/JP2025/000646 filed on Jan. 10, 2025, which claims priority from Japanese Patent Application No. 2024-011931 filed on Jan. 30, 2024. The entire content of each of the prior applications is incorporated herein by reference.

### TECHNICAL FIELD

The present disclosure relates to a printer.

### BACKGROUND ART

An inkjet printer (printing apparatus) includes a main body having a plurality of ink heads and supported by two legs, a casing covering the main body, and a plurality of ink tanks storing ink to be supplied to respective ones of the plurality of ink heads.

### SUMMARY

When an image is formed on a print medium, a pretreatment liquid serving as an undercoat for ink may be applied to the print medium before printing. Further, in order to coat an image formed on a print medium, a post-treatment liquid for forming an upper layer of ink may be applied after printing. In view of the above, the inventor of the present disclosure considered providing a printer with an ejection device that ejects a treatment liquid for applying the treatment liquid to a print medium, and a treatment liquid tank that stores the treatment liquid.

In the above-mentioned inkjet printer, an increase in the size of the printer is prevented, and an increase in the size of an installation area is also prevented. However, an ejection device or a treatment liquid tank is not disposed in the printer. When the treatment liquid tank is disposed outside the housing of the printer, a tank installation area different from a housing installation area which is an area where the housing is installed is occupied. In addition, since the consumption amount of treatment liquid may be larger than that of the ink, the capacity of the treatment liquid tank may be larger than the capacity of the ink tank. In this case, when the treatment liquid tank is disposed outside the housing as described above, a large tank installation area other than the housing installation area is occupied, and the installation area as a whole for the housing and the treatment liquid tank increases in size.

In view of the foregoing, an example of an object of this disclosure is to provide a printer that does not occupy a tank installation area other than a housing installation area.

According to one aspect, this specification discloses a printer. The printer includes a housing, a head, an ejection device, and a treatment liquid tank. The head is disposed in the housing. The head is configured to eject ink onto a print medium. The ejection device is configured to eject a treatment liquid onto the print medium. The treatment liquid forms an undercoat for ink or an overcoat for ink. The treatment liquid tank communicates with the ejection device. The treatment liquid tank is configured to store the treatment liquid to be supplied to the ejection device. The treatment liquid tank is disposed in the housing.

In the above-described printer, the treatment liquid tank is disposed in the housing. Therefore, when the printer is installed, a tank installation area other than the housing installation area is not occupied.

### BRIEF DESCRIPTION OF DRAWINGS

FIG. 1 is a perspective view of a printer.

FIG. 2 is a plan view showing an internal structure of the printer shown in FIG. 1.

FIG. 3 is a front view of the printer shown in FIG. 1.

FIG. 4 is a schematic view showing a supply line of a treatment liquid from a treatment liquid tank to an ejection device and a supply line of the treatment liquid from an external tank to the treatment liquid tank of the printer shown in FIG. 1.

FIG. 5 is a front view of the relevant part illustrating a state where a cover of the printer shown in FIG. 3 is removed.

FIG. 6 is a right side view of the printer shown in FIG. 1.

FIG. 7 is a perspective view illustrating a pump, a valve, and a connection portion disposed in a housing in a state where the cover of the printer shown in FIG. 1 is removed.

FIG. 8 is a plan view illustrating an outer shape of the housing of the printer shown in FIG. 1.

FIG. 9 is a block diagram showing an electrical configuration of the printer shown in FIG. 1.

FIG. 10 is a flowchart showing an example of a processing procedure executed when a print start command is input to the printer shown in FIG. 1.

FIG. 11A illustrates a situation when a platen reaches a treatment liquid ejection region from a set position.

FIG. 11B illustrates a situation when the platen has passed through the treatment liquid ejection region.

FIG. 12 is a flowchart showing an example of a processing procedure executed when a treatment liquid supply start command is input to the printer shown in FIG. 1.

### DESCRIPTION

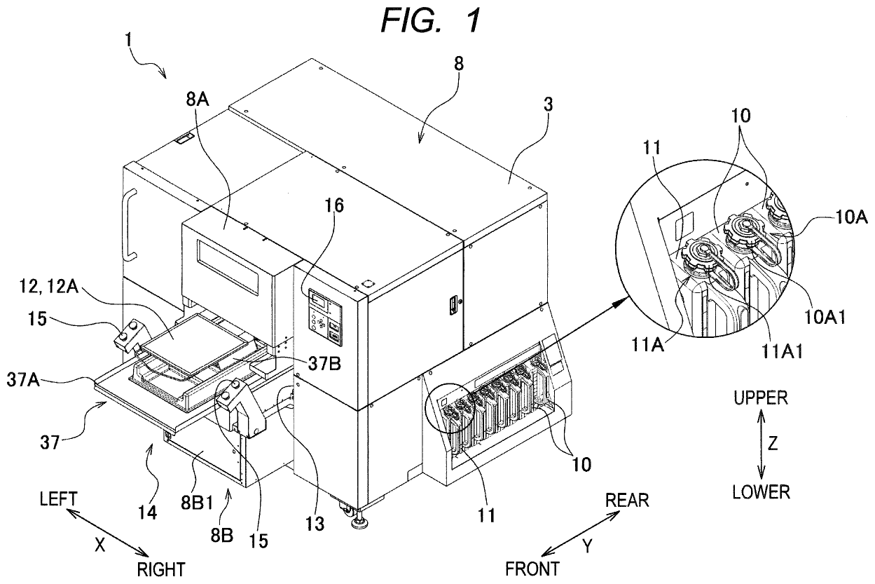

A printer 1 according to an embodiment of the present disclosure will be described with reference to the drawings. In the following description, an upper-lower direction Z (a “vertical direction” of the present disclosure) and a front-rear direction Y (a “particular direction crossing the vertical direction” of the present disclosure) are defined with reference to a state where the printer 1 is installed so as to be usable (a state shown in FIG. 1), and a left-right direction X is defined when the printer 1 is viewed from the front. In the following description, the left-right direction X may be referred to as a main scanning direction, and the front-rear direction Y may be referred to as a sub-scanning direction.

The printer 1 shown in FIG. 1 is an inkjet printer, and performs printing by ejecting ink onto a print medium. The printer 1 prints a color image on a print medium using ink of seven colors of white, black, yellow, cyan, magenta, green, and orange. The print medium is not particularly limited as long as an image is formed by ejecting ink, and examples include fabric and paper. In the present embodiment, the print medium refers to, for example, a T-shirt containing polyester fibers. When printing is performed on a print medium (T-shirt) by the printer 1, a treatment liquid that forms the undercoat (base) on which ink is ejected is applied to the print medium. The treatment liquid reacts with the ink ejected on the undercoat to aggregate the components of the ink, thereby preventing the occurrence of bleeding. The volatile component of the treatment liquid contains an organic acid such as formic acid.

Hereinafter, among the seven color inks, the white ink is referred to as “white ink”. The inks of six colors of black, cyan, yellow, magenta, green, and orange among the inks of seven colors are collectively referred to as “color inks” or are referred to as “color ink” in a case where any of the inks is not specified. In a case where the white ink and the color ink are collectively referred to, or in a case where any one of the white ink and the color ink is not specified, the white ink and the color ink are simply referred to as “ink”. The white ink is used as a portion representing a white color of an image or as the undercoat of color ink. The color ink is ejected onto the undercoat formed by the white ink, and is used to print a color image.

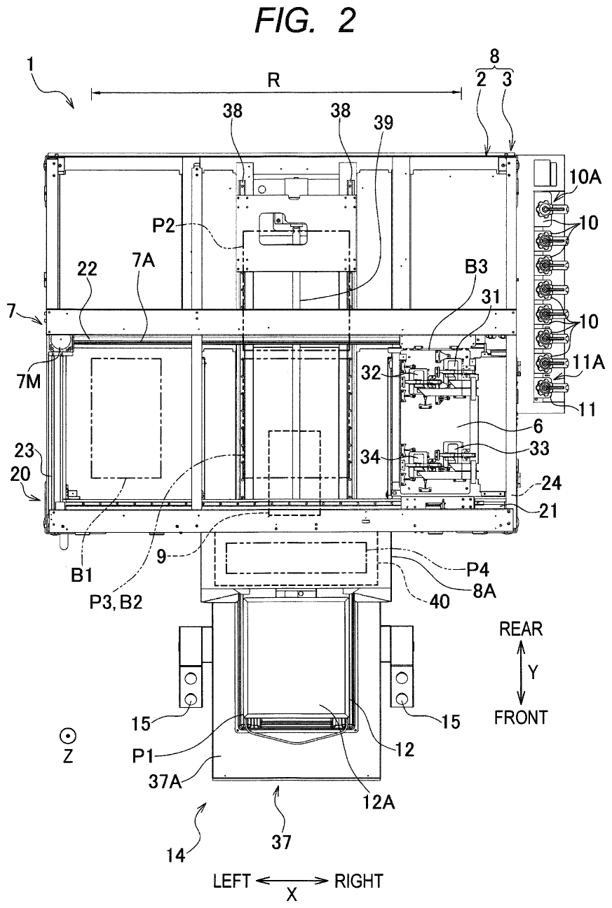

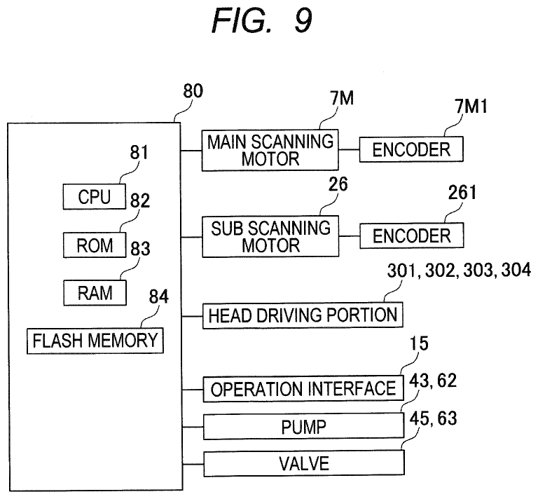

An external configuration of the printer 1 will be described with reference to FIGS. 1 to 3. As shown in FIG. 1, the printer 1 includes a housing 8, a platen 12, a conveyance mechanism 14, operation interfaces 15, a display (display screen) 16, an ejection device 40 (see FIG. 2), and a controller 80 (see FIG. 9).

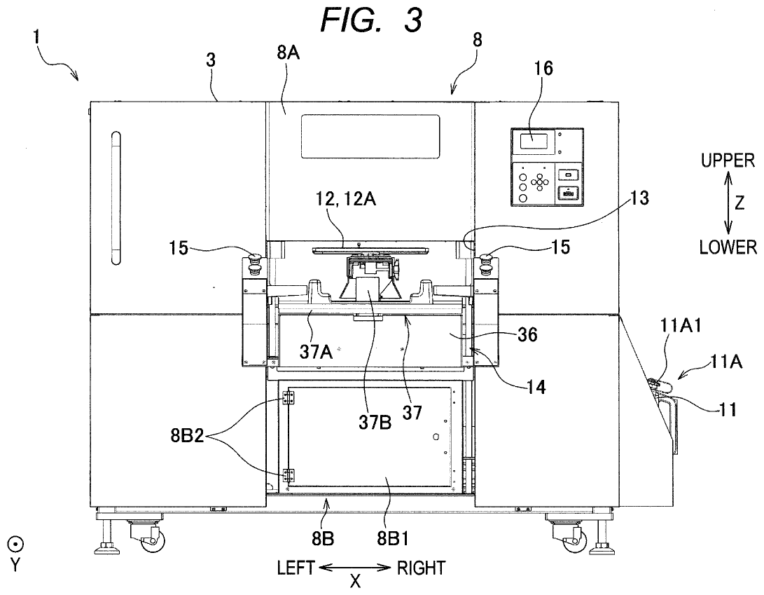

As shown in FIG. 1, the housing 8 has a substantially rectangular parallelepiped shape. As shown in FIGS. 2 and 3, the housing 8 includes a frame (frame body) 2 and a cover 3. The frame 2 is formed in a lattice shape by a plurality of shafts extending in the front-rear direction Y, the left-right direction X, or the upper-lower direction Z. The cover 3 includes a plurality of plate-like members fixed to the frame 2 to cover the outer periphery of the frame 2. A platen opening 13 is formed substantially at the center in the left-right direction X and the upper-lower direction Z of the front surface of the cover 3 of the housing 8. As shown in FIGS. 1 and 2, the platen (“support portion” of the present disclosure) 12 is formed of a plate-shaped member having a substantially rectangular planar shape. The upper surface of the platen 12 is a support surface 12A that supports the print medium. The support surface 12A has a quadrangular shape.

The housing 8 also has an ejection device cover 8A. The ejection device cover 8A is a front portion of the cover 3 and is disposed above the platen opening 13. The ejection device cover 8A is formed in a substantially rectangular-parallelepiped box shape with an opening on the lower side, and covers the ejection device 40. The ejection device cover 8A is disposed above the platen 12.

As shown in FIGS. 1 and 2, the housing 8 accommodates seven ink tanks 10 in which inks of seven colors are stored. The seven ink tanks 10 store inks of white, magenta, cyan, yellow, black, green, and orange in this order from the rear. Further, the housing 8 accommodates a cleaning liquid tank 11 for storing cleaning liquid. The cleaning liquid tank 11 is disposed forward of the seven ink tanks 10 and aligned with the ink tanks 10 in the front-rear direction Y. The cleaning liquid tank 11 is connected to a maintenance unit (not shown) by a pipe (not shown), and the cleaning liquid is supplied to the maintenance unit.

As shown in FIGS. 1 and 2, each ink tank 10 includes an ink supplying portion 10A. The cleaning liquid tank 11 also includes a cleaning liquid supplying portion 11A. The supplying portions 10A and 11A are portions for supplying the ink and the cleaning liquid corresponding to each tank, and are exposed to the outside from the housing 8. The ink supplying portion 10A has an ink supply port (not shown) for supplying ink into the ink tank 10, and a lid 10A1. The ink supply port is opened in an upper portion of the ink tank 10. The lid 10A1 is detachably attached to the ink supply port. Accordingly, the ink supply port is opened and closed.

The cleaning liquid supplying portion 11A has a cleaning liquid supply port (not shown) for supplying the cleaning liquid into the cleaning liquid tank 11 and a lid 11A1. The cleaning liquid supply port is opened in an upper portion of the cleaning liquid tank 11. The lid 11A1 is detachably attached to the cleaning liquid supply port. Accordingly, the cleaning liquid supply port is opened and closed. Further, a treatment liquid tank 9 is accommodated in the housing 8. The treatment liquid tank 9 communicates with the ejection device 40 and stores the treatment liquid to be supplied to the ejection device 40. The details of the treatment liquid tank 9 will be described later.

As shown in FIG. 1, the operation interfaces (for example, operation buttons) 15 are arranged at both sides of a platen support portion 37 described later in the left-right direction X. The platen support portion 37 is located forward of the platen opening 13. The operation interfaces 15 output information in response to an operation by an operator to the controller 80 described later. For example, the operator inputs a print start command (including print data) for starting printing by the printer 1 to the controller 80 by operating the operation interfaces 15. The print data includes image data of an image to be formed on a print medium. The display 16 is located to the upper right of the platen opening 13 on the front surface of the cover 3. The display 16 displays various types of information. The display 16 includes a touch panel, and has an operation button for supplying the treatment liquid.

The conveyance mechanism 14 conveys the platen 12 on which the print medium is placed between the inside and the outside of the housing 8 through the platen opening 13. When the platen 12 is located in a treatment liquid ejection region P4 (see FIG. 2), the treatment liquid is ejected from the ejection device 40, and the treatment liquid is applied to the print medium. Then, when the platen 12 is located in a print conveyance region P3 (a position indicated by a two-dot chain line in FIG. 2) inside the housing 8 shown in FIG. 2, ink is ejected from a head 30 (described later) to perform printing. As shown in FIGS. 2 and 3, the conveyance mechanism 14 includes a support base 36, a platen support portion 37, a pair of left and right rails 38, a transmission member 39, and a sub-scanning motor 26 (see FIG. 9).

As shown in FIGS. 2 and 3, the platen support portion 37 includes a tray 37A and a support portion 37B. A discharge port (not shown) for discharging the treatment liquid in the tray 37A is formed in the tray 37A. A pipe (not shown) is connected to the discharge port, and the treatment liquid in the tray 37A is discharged to a waste liquid unit through the pipe.

As shown in FIG. 3, the support portion 37B extends vertically and supports the platen 12 from below. The lower end of the support portion 37B is fixed to the tray 37A, and the tray 37A and the platen 12 are connected.

As shown in FIG. 2, the pair of left and right rails 38 extend in the front-rear direction Y and support the platen support portion 37 to be movable in the front-rear direction Y. The pair of rails 38 are disposed on the support base 36 disposed below the platen support portion 37. The support base 36 also extends in the front-rear direction Y. The support base 36 and the pair of rails 38 are formed to extend from the rear to the front of the housing 8 and protrude outside the housing 8. The transmission member 39 is connected to the platen support portion 37 and the sub-scanning motor 26, and moves the platen support portion 37 in the front-rear direction Y, that is, in the sub-scanning direction in accordance with the driving of the sub-scanning motor 26.

The operator places the print medium on the support surface 12A of the platen 12 in a state where the platen 12 is located forward of the front surface of the housing 8, that is, outside the housing 8. The position of the platen 12 shown in FIG. 2 is a set position P1 at which the platen 12 supports the print medium. The treatment liquid ejection region P4 is located in the middle of the conveyance path of the platen 12. The treatment liquid ejection region P4 is a region to which the treatment liquid is ejected from spray nozzles 41 (described later) of the ejection device 40, and is located below the spray nozzles 41 (that is, in the ejection direction of the treatment liquid). Further, the platen 12 moves from the set position P1 to a pre-printing standby position P2 (a position indicated by a two-dot chain line in FIG. 2) before printing on the print medium. The pre-printing standby position P2 is located rearward of the treatment liquid ejection region P4 and the printing conveyance region P3 and at the rear end of the conveyance path of the platen 12. The printing conveyance region P3 is a region that overlaps, in the upper-lower direction Z, a movement path of the head 30 in the main scanning direction (the left-right direction X) in the conveyance path of the platen 12. The movement path of the head 30 in the main scanning direction is located between the rear end of the rearmost head 30 (white head 31) and the front end of the foremost head 30 (color head 34).

The internal structure of the printer 1 will be described. As shown in FIG. 2, the printer 1 includes heads 31, 32, 33 and 34 and a movement mechanism 7 inside the housing 8. The movement mechanism 7 includes a guide shaft 20 fixed to the frame 2 and a carriage 6. As shown in FIG. 2, the guide shaft 20 includes a front shaft 21, a rear shaft 22, a left shaft 23, and a right shaft 24.

As shown in FIG. 2, the front shaft 21 is disposed at the front end of the frame 2 and extends in the left-right direction X from the left end to the right end of the frame 2. The rear shaft 22 is disposed substantially at the center of the frame 2 in the front-rear direction Y, and extends in the left-right direction X from the left end to the right end of the frame 2. The left shaft 23 is disposed at the left end of the frame 2, and extends in the front-rear direction Y from the left end of the front shaft 21 to the left end of the rear shaft 22. The right shaft 24 is disposed at the right end of the frame 2, and extends in the front-rear direction Y from the right end of the front shaft 21 to the right end of the rear shaft 22. The front shaft 21 and the rear shaft 22 support the carriage 6. The conveyance mechanism 14 is fixed to the frame 2.

As shown in FIG. 2, the carriage 6 is supported by the front shaft 21 and the rear shaft 22 to be movable in the main scanning direction. The carriage 6 has a plate shape and extends in the front-rear direction Y and the left-right direction X. The carriage 6 extends from the front shaft 21 to the rear shaft 22. As shown in FIG. 2, white heads 31 and 32 and color heads 33 and 34 are disposed on the carriage 6.

The white heads 31 and 32 and the color heads 33 and 34 have the same structure, and have a rectangular parallelepiped shape in this embodiment. Hereinafter, the white heads 31 and 32 and the color heads 33 and 34 will be collectively referred to as “head 30” when any of the heads is not specified. As shown in FIG. 2, the white heads 31 and 32 are located at a rear portion of the carriage 6. The white heads 31 and 32 are arranged to be shifted each other in the front-rear direction Y. The white heads 31 and 32 are connected to the ink tank 10 storing the white ink via pipes, and the white ink is supplied from the ink tank 10.

As shown in FIG. 2, the color heads 33 and 34 are located forward of the white heads 31 and 32. Similarly to the white heads 31 and 32, the color heads 33 and 34 are also arranged to be shifted from each other in the front-rear direction Y. The color heads 33 and 34 are connected to six ink tanks 10 storing color inks via pipes, and the color inks are supplied from the ink tanks 10.

A plurality of nozzles (not shown) are formed on the lower surface of the head 30. The plurality of nozzles of the white heads 31 and 32 eject the white ink downward. The plurality of nozzles of each of the color heads 33 and 34 are arranged such that six nozzle arrays extending in the front-rear direction Y are arranged in the left-right direction X. Color inks of different colors correspond to the six nozzle arrays of each of the color heads 33 and 34. That is, the plurality of nozzles of each of the color heads 33,34 eject the color ink of the color corresponding to each of the nozzle arrays downward.

The movement mechanism 7 includes a drive belt 7A and a main scanning motor 7M. The drive belt 7A is connected to the rear end of the carriage 6. The drive belt 7A is located on the rear shaft 22 and extends in the left-right direction X. The left end of the drive belt 7A is connected to the main scanning motor 7M. When the main scanning motor 7M is driven, the drive belt 7A moves the carriage 6 in the left-right direction X along the front shaft 21 and the rear shaft 22. That is, the movement mechanism 7 moves the carriage 6 on which the head 30 is mounted in the main scanning direction. FIG. 2 shows a state where the carriage 6 is located at the right end of a movement range R.

FIG. 2 shows a maximum range of the movement range R of the head 30 in which the carriage 6 is movable in the main scanning direction. The head 30 is mainly located at any one of a maintenance position B1, an ejection region B2, and a head standby position B3 by the movement mechanism 7. The maintenance position B1 is located at the left end of the movement range R of the head 30, and is a position where the head 30 is maintained by a maintenance unit such as a wiper or a cap (not shown). The printer 1 moves the head 30 to the maintenance position B1 when printing is not performed, and performs maintenance by the maintenance unit. The ejection region B2 is a region between the maintenance position B1 and the head standby position B3 in the main scanning direction. The ejection region B2 is a region overlapping, in the upper-lower direction Z, the conveyance path of the platen 12 (the print conveyance region P3) in the movement path of the head 30. When the head 30 passes through the ejection region B2 by the carriage 6, the head 30 ejects ink according to print data, and printing is performed on the print medium on the platen 12. The head standby position B3 is at the right end of the movement range R of the head 30, and is a position at which the head 30 is located when the operator performs an operation such as cleaning on the head 30. The printer 1 moves the head 30 to the head standby position B3 and causes the head 30 to wait, for example, based on a command input from the operation interface 15 by an operation of the operator.

The printer 1 moves the platen 12 in the sub-scanning direction by driving the sub-scanning motor 26 in the print conveyance region P3, and moves the carriage 6 in the main scanning direction by driving the main scanning motor 7M in the ejection region B2.

An operation of moving the head 30 in the main scanning direction and ejecting the ink to the print medium when the head 30 faces the print medium is referred to as “ejection scanning”. The printer 1 performs printing on the print medium by repeating the ejection scanning and the movement of the platen 12 in the sub-scanning direction. For example, the printer 1 ejects the white ink from the white heads 31 and 32 in the ejection scanning to form the undercoat (base) of the color ink on the print medium. The printer 1 prints a color image by ejecting color ink from the color heads 33 and 34 onto the undercoat formed on the print medium in the ejection scanning.

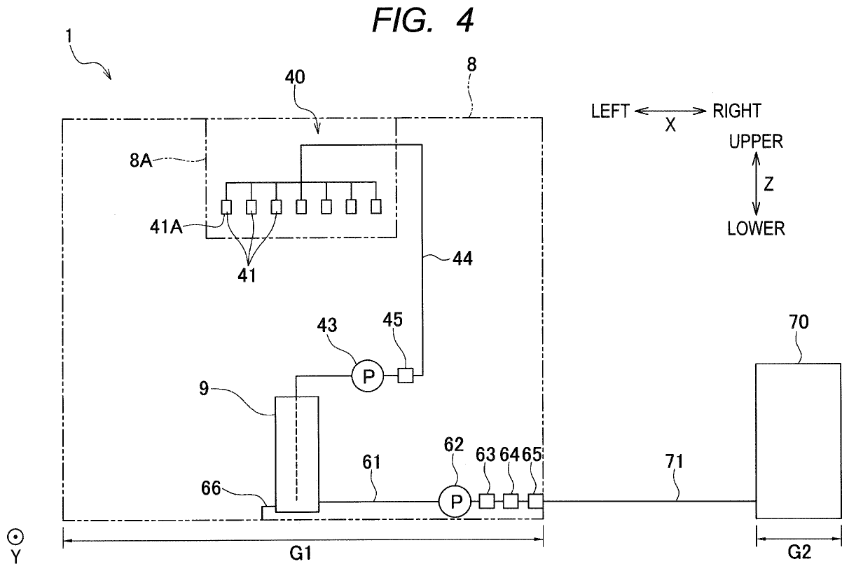

As shown in FIG. 4, the ejection device 40 includes seven spray nozzles 41 arranged in the left-right direction X. The spray nozzles 41 are covered by an ejection device cover 8A. As shown in FIG. 4, the spray nozzle 41 has an ejection port 41A on its lower surface. The spray nozzle 41 is configured to eject the treatment liquid in a mist form downward from the ejection port 41A.

The ejection device 40 further includes a pump 43, a pipe 44 connecting the treatment liquid tank 9 and the spray nozzles 41, and a valve 45. The pump 43 is disposed in the middle of the pipe 44, and supplies the treatment liquid in the treatment liquid tank 9 to the seven spray nozzles 41 under the control of the controller 80. The valve 45 is disposed in the middle of the pipe 44 and between the seven spray nozzles 41 and the pump 43. The valve 45 is an on-off valve, and takes an open state when the treatment liquid is supplied from the treatment liquid tank 9 to the spray nozzles 41, and takes a closed state when the treatment liquid is not supplied from the treatment liquid tank 9 to the spray nozzles 41. The opening-closing operation of the valve 45 is controlled by the controller 80.

In such a configuration, the controller 80 drives the pump 43 and controls the valve 45 to be in an open state, so that the treatment liquid in the treatment liquid tank 9 is supplied to the spray nozzles 41 via the pipe 44. The treatment liquid supplied to the spray nozzles 41 spreads in a fan shape and is ejected in a mist form from the spray nozzles 41. Accordingly, the treatment liquid is applied to the print medium.

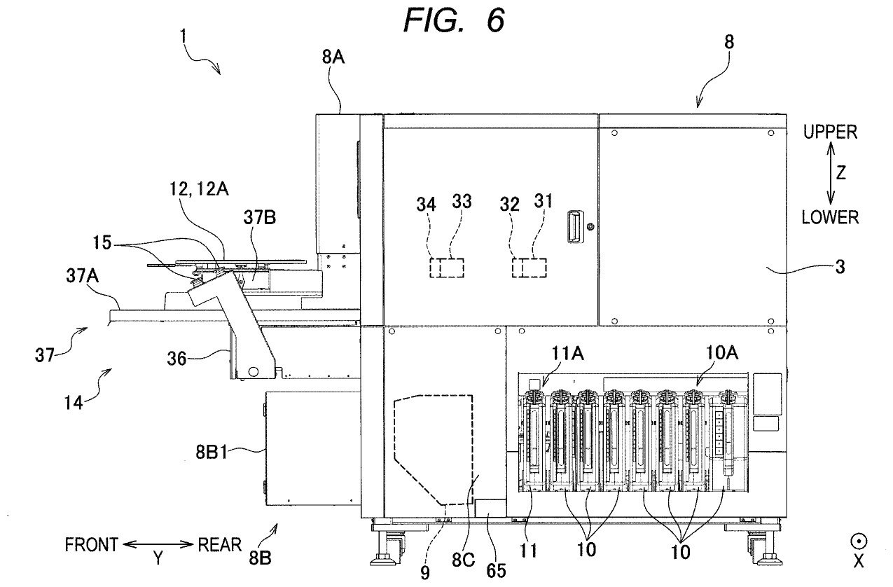

As shown in FIGS. 2, 5, and 6, the entirety of the treatment liquid tank 9 is disposed in the housing 8. The treatment liquid tank 9 has a substantially rectangular parallelepiped shape, and an internal space for storing the treatment liquid is formed in the treatment liquid tank 9. As shown in FIG. 6, the treatment liquid tank 9 is disposed below the head 30 and the platen 12 and forward of the ink tanks 10 and the cleaning liquid tank 11. More specifically, as shown in FIG. 2, the treatment liquid tank 9 is disposed substantially at the center of the housing 8 in the left-right direction X. The treatment liquid tank 9 is disposed lower than the platen support portion 37 and the support base 36 in the housing 8 so as to overlap the platen support portion 37 and the support base 36 in the upper-lower direction Z.

As shown in FIGS. 1 and 6, the housing 8 includes a protruding portion 8B protruding forward. The protruding portion 8B is disposed in a front portion of the cover 3 and below the platen opening 13. The protruding portion 8B has a substantially rectangular parallelepiped shape and is disposed below the support base 36 to overlap the support base 36 in the upper-lower direction Z. As shown in FIG. 3, the protruding portion 8B includes a door 8B1 on the front surface of the protruding portion 8B. The protruding portion 8B has an internal space, and is a rectangular tube whose front is closed by the door 8B1. The door 8B1 is configured to open and close by two hinges 8B2, and the inside of the housing 8 communicates with the outside by opening the door 8B1.

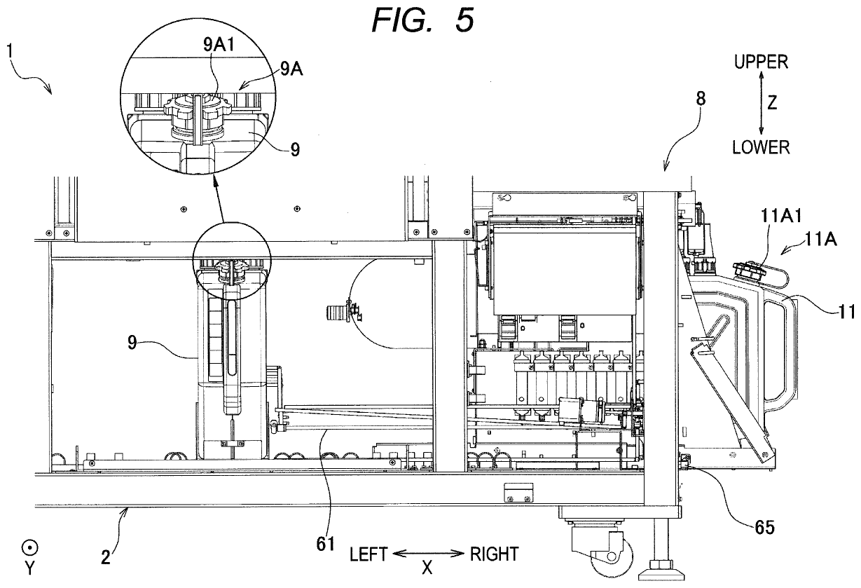

As shown in FIGS. 3 and 5, the treatment liquid tank 9 faces the door 8B1 in the front-rear direction Y. As shown in FIG. 5, the treatment liquid tank 9 includes a treatment liquid supplying portion 9A. The treatment liquid supplying portion 9A has a supply port (not shown) for supplying the treatment liquid into the treatment liquid tank 9. The treatment liquid supplying portion 9A includes a lid 9A1. The supply port is opened in a front upper portion of the treatment liquid tank 9. The lid 9A1 is detachably attached to the supply port. Accordingly, the supply port is opened and closed.

With such a configuration, by opening the door 8B1, the operator is able to open the lid 9A1 of the treatment liquid tank 9. This allows the operator to directly supply the treatment liquid in a treatment liquid bottle containing the treatment liquid from the supply port of the treatment liquid tank 9.

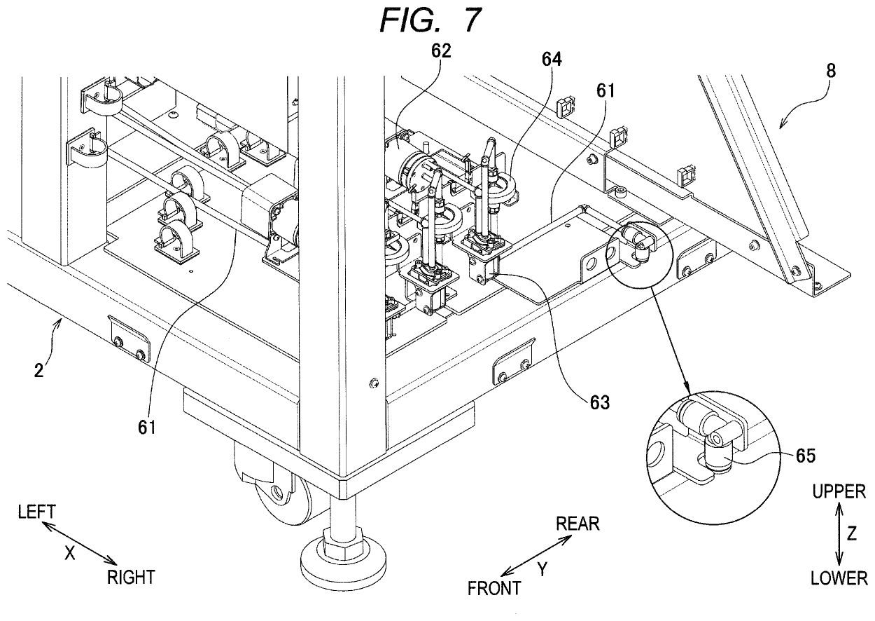

As shown in FIG. 4, a pipe 61, a pump 62, a valve 63, a filter 64, and a connection portion (connector) 65 are disposed in the housing 8. As shown in FIG. 7, the pipe 61, the pump 62, the valve 63, the filter 64, and the connection portion 65 are disposed rightward of the treatment liquid tank 9 and forward of the ink tanks 10 and the cleaning liquid tank 11.

As shown in FIG. 4, one end of the pipe 61 (“supply passage” of the present disclosure) is connected to the treatment liquid tank 9, and the other end is connected to the connection portion 65. The pipe 61 allows the treatment liquid tank 9 to communicate with the outside of the housing 8 via the connection portion 65. As shown in FIG. 6, the connection portion 65 is fixed to a right side surface 8C of the housing 8. The connection portion 65 is a known female joint and is connectable to a male joint. That is, the connection portion 65 is connectable to a male joint at a distal end of a pipe 71 connected to an external tank 70 disposed outside the housing 8. As shown in FIG. 4, the external tank 70 is disposed in an external tank installation area G2 for installing the external tank 70, which is an area different from a housing installation area G1 for installing the housing 8.

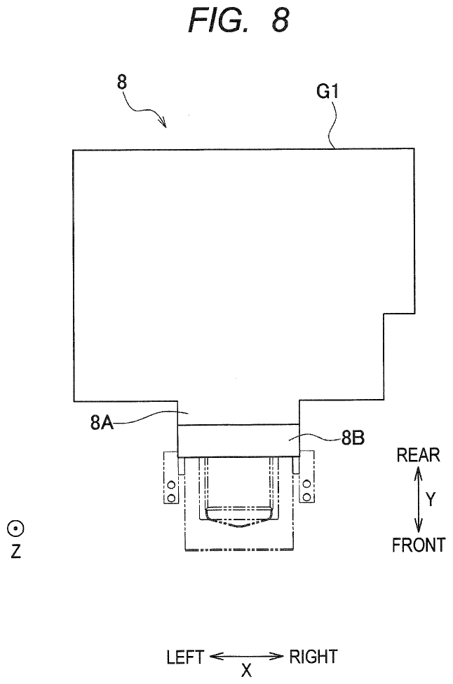

The housing installation area G1 of the printer 1 will be described. As shown in FIG. 8, the housing installation area G1 in the present embodiment is an area surrounded by an outline (indicated by a solid line in FIG. 8) of the housing 8 when the installed printer 1 is viewed from above. The housing installation area G1 does not include the operation interfaces 15, a front portion of the platen support portion 37, a front portion of the support base 36 (indicated by two-dot chain lines in FIG. 8), and so on that are located forward of the front end of the protruding portion 8B of the housing 8.

The treatment liquid that is supplied to the treatment liquid tank 9 is stored in the external tank 70. The external tank 70 is configured to store a larger amount of the treatment liquid than the treatment liquid tank 9. Since the connection portion 65 is fixed to the right side surface of the housing 8 as shown in FIG. 4, the pipe 71 connected to the external tank 70 is easily connected to the connection portion 65 from the outside of the housing 8. The connection portion 65 may be of any type as long as the pipe 61 and the pipe 71 are connectable.

As shown in FIGS. 4 and 7, the pump 62 is disposed in the middle of the pipe 61, and is configured to supply the treatment liquid in the external tank 70 to the treatment liquid tank 9 under the control of the controller 80. The pump 62 is closer to the right side surface of the housing 8 than the treatment liquid tank 9 is. That is, the pump 62 is closer to the outside of the housing 8 than the treatment liquid tank 9 is in the left-right direction X. This contributes to easier access by the operator to the inside of the housing 8 from the outside to perform maintenance of the pump 62.

The valve 63 is disposed in the middle of the pipe 61 between the pump 62 and the filter 64. The valve 63 is an on-off valve, and takes an open state when the treatment liquid is supplied from the outside to the treatment liquid tank 9, and takes a closed state when the treatment liquid is not supplied from the outside to the treatment liquid tank 9. The opening-closing operation of the valve 63 is controlled by the controller 80.

The filter 64 is disposed in the middle of the pipe 61 between the valve 63 and the connection portion 65. The filter 64 captures foreign matter in the treatment liquid supplied from the external tank 70 via the connection portion 65. This reduces mixing of foreign matter into the treatment liquid supplied to the treatment liquid tank 9 via the supply passage. The filter 64 is closer to the right side surface of the housing 8 than the treatment liquid tank 9 is. That is, the filter 64 is closer to the outside of the housing 8 than the treatment liquid tank 9 is in the left-right direction X. This contributes to easier access by the operator to the inside of the housing 8 from the outside and cleaning the filter 64.

As shown in FIG. 4, a pipe (“discharge passage” of the present disclosure) 66 is disposed at the housing 8. The one end of the pipe 66 is connected to a lower portion of the treatment liquid tank 9. The pipe 66 communicates with the internal space of the treatment liquid tank 9. The other end of the pipe 66 is located outside the housing 8 and includes a plug (not shown). Accordingly, for example, by opening the plug of the pipe 66 before transporting the printer 1, the treatment liquid in the treatment liquid tank 9 is discharged to the outside. This prevents the treatment liquid from leaking during transport of the printer 1.

An electrical configuration of the printer 1 will be described with reference to FIG. 9. The controller 80 includes a CPU 81, a ROM 82, a RAM 83, and a flash memory 84. The CPU 81 controls the printer 1 and is electrically connected to the ROM 82, the RAM 83 and the flash memory 84. The ROM 82 stores a control program for the CPU 81 to control the operation of the printer 1, information used by the CPU 81 that executes various programs, and so on. The ROM 82 stores, for example, the positions of the carriage 6 (the head 30) corresponding to the rotation angles of the main scanning motor 7M, and stores the positions of the platen 12 corresponding to the rotation angles of the sub-scanning motor 26. The RAM 83 temporarily stores various types of information used in the control program. The flash memory 84 is nonvolatile, and stores print data and so on for performing printing.

As shown in FIG. 9, the controller 80 is electrically connected to the main scanning motor 7M, the sub-scanning motor 26, the four head driving portions 301, 302, 303 and 304, the operation interfaces 15, the pumps 43 and 62, and the valves 45 and 63. The main scanning motor 7M, the sub-scanning motor 26, the head driving portions 301, 302, 303 and 304, the pumps 43 and 62, and the valves 45 and 63 are driven under the control of the controller 80.

Encoders 7M1 and 261 are provided for the main scanning motor 7M and the sub-scanning motor 26, respectively. The encoder 7M1 detects the rotation angle of the main scanning motor 7M, and outputs a detection result to the controller 80. The encoder 261 detects the rotation angle of the sub-scanning motor 26 and outputs a detection result to the controller 80.

The four head driving portions 301, 302, 303 and 304 correspond to the white heads 31 and 32 and the color heads 33 and 34, respectively. The four head driving portions 301, 302, 303 and 304 are included in the heads 31, 32, 33 and 34, respectively. Each of the head driving portions 301, 302, 303 and 304 includes a plurality of driving elements (piezoelectric elements or heating elements) configured to selectively apply energy to ink in a plurality of individual flow paths communicating with a plurality of nozzles of the head 30. The head driving portions 301, 302, 303 and 304 are driven to apply energy to the ink in the white heads 31 and 32 and the color heads 33 and 34, respectively, and selectively eject the ink from the corresponding nozzles.

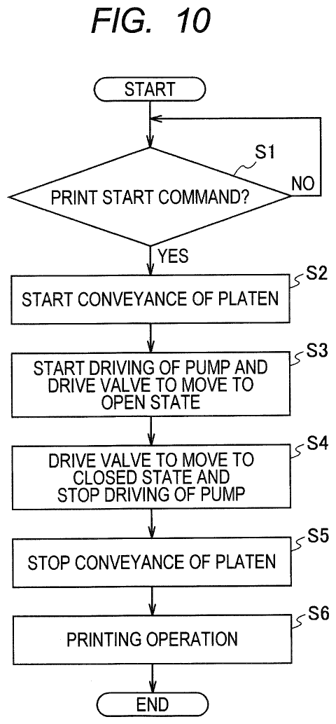

With reference to FIG. 10, a control operation by the controller 80 when an image is printed on a print medium will be described. When the operation interface 15 is operated by the operator and a print start command is input to the printer 1, the controller 80 reads the control program from the ROM 82 and executes the flow of FIG. 10. Hereinafter, the flow of FIG. 10 will be described.

First, the controller 80 determines whether a print start command is input (S1). Before operating the operation interface 15 to input the print start command, the operator places a print medium (for example, a T-shirt) on which no treatment liquid has been applied on the support surface 12A of the platen 12. The platen 12 is disposed at the set position P1 when printing is not performed. In the printer 1, when printing is not performed, the head 30 is normally disposed at the maintenance position B1, and the plurality of nozzles of the head 30 are covered with a cap of a maintenance unit (not shown), that is, capping is performed.

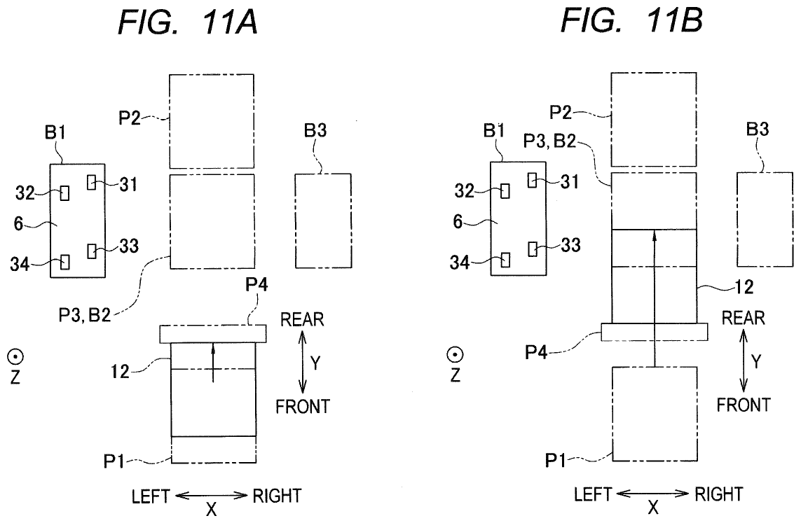

When the print start command is not input (S1: NO), the step S1 is repeated until the print start command is input. When the print start command is input (S1: YES), as shown in FIG. 11A, the controller 80 controls the sub-scanning motor 26 to start conveying the platen 12 from the set position P1 toward the treatment liquid ejection region P4 (S2). At this time, the platen 12 is conveyed rearward. The “rearward” is an example of a “first direction” along the particular direction.

Next, the controller 80 starts driving the pump 43, and then drives the valve 45 to the open state (S3). As a result, the treatment liquid is supplied from the treatment liquid tank 9 to the spray nozzles 41 via the pipe 44, and the treatment liquid is ejected in a mist form from the spray nozzles 41. Therefore, the treatment liquid ejected in a mist form is applied to the print medium supported by the platen 12 that is passing through the treatment liquid ejection region P4. As a result, the undercoat in which the treatment liquid is substantially uniformly applied is formed on the print medium.

Next, as shown in FIG. 11B, the controller 80 drives the valve 45 to the closed state and stops the driving of the pump 43 at the timing when the platen 12 has passed the treatment liquid ejection region P4 (S4). This operation stops the supply of the treatment liquid to the spray nozzles 41, and stops the ejection of the treatment liquid from the spray nozzles 41. In the present embodiment, the treatment liquid is applied to the entire surface of the print medium by ejecting the treatment liquid to the entirety of the support surface 12A of the platen 12. Alternatively, the treatment liquid may be applied to a part of the print medium in the front-rear direction Y by appropriately changing the drive timing of the pump 43 and the valve 45. In a case where the treatment liquid is applied to a part of the print medium, the treatment liquid may be applied to a region corresponding to an image region formed by ejecting the ink onto the print medium.

Next, in response to determining that the platen 12 reaches the pre-printing standby position P2 based on the detection result from the encoder 261, the controller 80 controls the sub-scanning motor 26 to stop conveying the platen 12 (S5).

Next, the controller 80 executes a printing operation for printing an image on the print medium (S6). The controller 80 controls the sub-scanning motor 26 based on the detection result from the encoder 261 to move the platen 12 from the pre-printing standby position P2 to the printing conveyance region P3.

Then, the controller 80 controls the main scanning motor 7M based on the detection result from the encoder 7M1, moves the carriage 6 from the maintenance position B1 to the ejection region B2, and causes the head 30 to face the print medium placed on the platen 12.

In a state where at least a part of the platen 12 is located in the print conveyance region P3 and where the carriage 6 is located in the ejection region B2, the controller 80 controls the head driving portions 301 to 304, the main scanning motor 7M, and the sub-scanning motor 26 to alternately repeat ejection scanning and forward movement of the platen 12, thereby performing printing on the print medium. That is, at the time of printing on the print medium, the platen 12 is conveyed forward from the pre-printing standby position P2 to the printing conveyance region P3. At this time, the platen 12 is conveyed forward. The “forward” is an example of a “second direction” along the particular direction. The white heads 31 and 32 are located farther rearward (in the “first direction”) than the color heads 33 and 34. Thus, first, the white ink is ejected from the nozzles of the white heads 31 and 32 on the undercoat of the print medium formed by applying the treatment liquid, so that the undercoat (mainly for color ink) is formed. Then, the ink is ejected from the nozzles of the color heads 33 and 34 onto the undercoat formed on the print medium having passed the white heads 31 and 32, so that an image is formed. The undercoat portion formed with white ink is used as a white portion of the image. Therefore, the color ink is not ejected onto the undercoat portion.

When printing based on print data on the print medium is finished (an end of the printing operation), the controller 80 controls the sub-scanning motor 26 based on the detection result from the encoder 261 to stop the platen 12 at the set position P1. The operator removes the print medium on which the image is formed from the platen 12 disposed at the set position P1. At this time, the controller 80 controls the main scanning motor 7M based on the detection result from the encoder 7M1, moves the carriage 6 leftward from the ejection region B2, and stops the carriage 6 at the maintenance position B1. In this way, the flow of FIG. 10 ends.

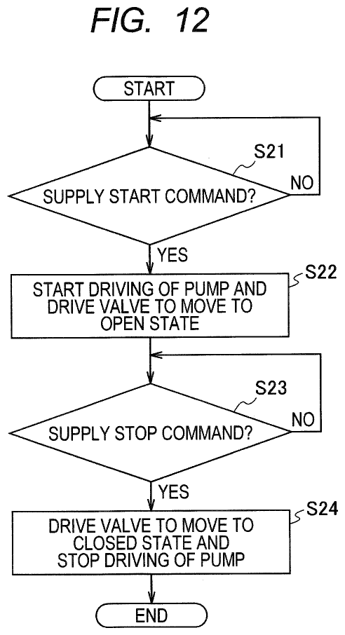

With reference to FIG. 12, a control operation by the controller 80 when the treatment liquid of the external tank 70 is supplied to the treatment liquid tank 9 will be described. The operator connects the pipe 71 connected to the external tank 70 to the connection portion 65. Thereafter, the operator operates an operation button of the display 16 when supplying the treatment liquid of the external tank 70 to the treatment liquid tank 9. The operator also operates the operation button when stopping the supply of the treatment liquid to the treatment liquid tank 9. When the operation button of the display 16 is operated by the operator and a treatment liquid supply start command is input to the printer 1, the controller 80 reads a control program from the ROM 82 and executes the flow of FIG. 12. Hereinafter, the flow of FIG. 12 will be described.

First, the controller 80 determines whether a treatment liquid supply start command is input (S21). When the treatment liquid supply start command is not input (S21: NO), the step S21 is repeated until the treatment liquid supply start command is input. When the treatment liquid supply start command is input (S21: YES), the controller 80 starts to drive the pump 62, and then drives the valve 63 to the open state (S22). Thereby, the treatment liquid in the external tank 70 is supplied to the treatment liquid tank 9 via the pipe 61.

Next, the controller 80 determines whether a treatment liquid supply stop command is input (S23). When the treatment liquid supply stop command is not input (S23: NO), the step S23 is repeated until the treatment liquid supply stop command is input. When the treatment liquid supply stop command is input (S23: YES), the controller 80 drives the valve 63 to the closed state and stops the driving of the pump 62 (S24). Thereby, the supply of the treatment liquid in the external tank 70 to the treatment liquid tank 9 is stopped. In this way, the flow of FIG. 12 ends.

A liquid amount sensor for detecting the amount of the treatment liquid in the treatment liquid tank 9 may be further provided. In this case, when the liquid amount sensor detects that the amount of the treatment liquid in the treatment liquid tank 9 is equal to or less than a first amount (a lower limit value), an empty signal may be output to the controller 80. The controller 80 may determine that the treatment liquid supply start command is received when the empty signal is received. In this way, by connecting the pipe 71 connected to the external tank 70 to the connection portion 65, the treatment liquid in the external tank 70 is automatically supplied to the treatment liquid tank 9 via the pipe 61 when the amount of the treatment liquid in the treatment liquid tank 9 becomes equal to or less than the first amount. Further, when the liquid amount sensor detects that the amount of the treatment liquid in the treatment liquid tank 9 is equal to or larger than a second amount (an upper limit value) larger than the first amount, a full signal indicating that the amount of the treatment liquid in the treatment liquid tank 9 is full may be output to the controller 80. The controller 80 may determine that the treatment liquid supply stop command is received when the full signal is received. In this way, the supply of the treatment liquid in the external tank 70 to the treatment liquid tank 9 is automatically stopped.

As described above, according to the printer 1 of the present embodiment, the treatment liquid tank 9 is disposed in the housing 8. Therefore, when the printer 1 is installed, a tank installation area for installing the treatment liquid tank 9, which is an area different from the housing installation area G1, is not occupied.

The treatment liquid tank 9 is located lower than the head 30. As a result, the center of gravity of the printer 1 is lower than when the treatment liquid tank 9 is disposed above the head 30. This improves the stability of the installed printer 1, and prevents the printer 1 from falling over, for example.

The treatment liquid tank 9 is located lower than the platen 12. Accordingly, the center of gravity of the printer 1 is lower than when the treatment liquid tank 9 is disposed above the platen 12. This improves the stability of the installed printer 1, and prevents the printer 1 from falling over, for example.

The platen 12 is disposed at a certain height from the installation surface of the printer 1 so that the operator sets a print medium on the platen 12. The platen 12 is configured to be movable in the front-rear direction Y, and the head 30 and the carriage 6 are disposed above the platen 12. A maintenance unit such as a wiper or a cap is disposed at a position below the head 30 located at the maintenance position B1. Thus, in the housing 8, a dead space is likely to occur at a position below the conveyance path of the platen 12. The treatment liquid tank 9 in the present embodiment is disposed at a position below the conveyance path of the platen 12. Therefore, a dead space is less likely to be generated at a position below the conveyance path of the platen 12, and the space of the printer 1 is reduced. This prevents an increase in the size of the printer 1 including the treatment liquid tank 9, and prevents an increase in the size of the housing installation area G1.

The pipe 61 is connected to the treatment liquid tank 9. This contributes to supplying the treatment liquid to the treatment liquid tank 9 from the outside of the housing 8.

The connection portion 65 is disposed at the right side surface of the housing 8. This contributes to supplying the treatment liquid in the external tank 70 to the treatment liquid tank 9.

The pump 62 is disposed in the housing 8. This contributes to supplying the treatment liquid in the external tank 70 to the treatment liquid tank 9.

The ink supplying portion 10A of the ink tank 10 is disposed to be exposed to the outside of the housing 8. This contributes to supplying ink to the ink tank 10.

The door 8B1 facing the treatment liquid tank 9 is coupled to the housing. This contributes to performing maintenance of the treatment liquid tank 9 (such as checking for leakage of the treatment liquid).

The housing 8 includes the protruding portion 8B, which contributes improvement in operability. More specifically, since the protruding portion 8B is provided, the door 8B1 is located farther forward in the printer 1 than a case where the protruding portion 8B is not provided. This makes it easier for the user to operate the door 8B1 and to visually check the inside (for example, the treatment liquid tank 9). If the protruding portion 8B is not provided, the user has to reach under the platen 12 to operate the door 8B1.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

As a modification, a plurality of treatment liquid tanks 9 may be disposed in the housing 8. In this case, a treatment liquid supply line for supplying the treatment liquid from each treatment liquid tank 9 to the spray nozzles 41 is configured to be switchable. This contributes to supplying the treatment liquid from an intended treatment liquid tank 9 to the spray nozzles 41. This also contributes to storing different types of treatment liquids in respective ones of the plurality of treatment liquid tanks 9, and to eject an intended treatment liquid from the spray nozzles 41. Alternatively, the same type of treatment liquid may be stored in the plurality of treatment liquid tanks 9, and a larger amount of treatment liquid is stored. Further, the plurality of treatment liquid tanks 9 are arranged in a dispersed manner (at different positions) in the housing 8. Further, when the treatment liquid in one treatment liquid tank 9 runs out, the treatment liquid in another treatment liquid tank 9 is supplied to the spray nozzles 41.

The treatment liquid tank 9 may be disposed above the platen 12 or the head 30. The treatment liquid tank 9 may not overlap the platen support portion 37 in the upper-lower direction Z. That is, the treatment liquid tank 9 may be disposed leftward or rightward of the platen support portion 37 in the left-right direction X. The treatment liquid tank 9 may be disposed leftward or rightward of the platen 12 or the platen support portion 37 below the head 30. The treatment liquid tank 9 may be disposed rearward of the head 30 in the front-rear direction Y.

In the above-described embodiment, the spray nozzles 41 of the ejection device 40 are covered with the ejection device cover 8A of the housing 8, but may be disposed outside the housing 8 and above the conveyance path of the platen 12. The ejection device cover 8A may be omitted from the housing 8.

The ejection device 40 is not limited to the configuration in which the treatment liquid is ejected from the spray nozzles 41. The ejection device 40 may have a configuration similar to that of the head 30. Although the ejection device 40 in the above-described embodiment has seven spray nozzles 41, the ejection device 40 may have one to six or eight or more spray nozzles 41.

Although the ejection device 40 ejects a pretreatment liquid for forming an undercoat in the above-described embodiment, the ejection device 40 may eject a post-treatment liquid for overcoating an image on the print medium. That is, the post-treatment liquid may be ejected onto the print medium after the ink is ejected onto the print medium to form the image. In this case, the step S3 may be executed after the printing operation of S6, that is, by the time the platen 12 reaches the treatment liquid ejection region P4. Then, the step S4 may be executed after the platen 12 has passed the treatment liquid ejection region P4. In this way, overcoating (forming a top coat for ink) of the image on the print medium is performed.

As a modification, the number of nozzle arrays of the color heads 33 and 34 may be four, and magenta, cyan, yellow, and black inks may be ejected from the four nozzle arrays of each of the heads 33 and 34. That is, the green and orange inks may not be ejected from the color heads 33 and 34. In this case, the ink tanks for storing the green and orange inks may be omitted.

As another modification, a total of six heads may be disposed by additionally disposing a head between the head 31 and the head 33 and disposing a head between the head 32 and the head 34 in the front-rear direction Y. In this case, each of the color heads 33 and 34 may have four nozzle arrays, and magenta, cyan, yellow, and black inks may be ejected from the four nozzle arrays of each of the heads 33 and 34, and green and orange inks may be ejected from the two additional heads. As still another modification, the two additional heads may be used as the ejection device, and a post-treatment liquid for overcoating the image of the print medium may be ejected from the two additional heads instead of the green and orange inks. In this case, a post-treatment liquid tank storing the post-treatment liquid may be disposed instead of the ink tank storing the green and orange inks, and the post-treatment liquid may be supplied from the post-treatment liquid tank to the two additional heads. Alternatively, similarly to the treatment liquid tank 9, a post-treatment liquid tank may be disposed in the housing 8, and the post-treatment liquid may be supplied from the post-treatment liquid tank to the two additional heads.

The conveyance mechanism 14 may not include the sub-scanning motor 26. In this case, the platen 12 may be moved manually. That is, the conveyance mechanism may have a configuration capable of moving the platen 12 between the set position P1 and a passed position at which the platen 12 has passed the treatment liquid ejection region P4.

In the above-described embodiment, the disclosure is applied to a printer including a so-called serial head 30 that ejects ink from a plurality of nozzles while being moved along the main scanning direction (the left-right direction X) by the movement mechanism 7, but the disclosure is not limited to this example. For example, the disclosure may also be applied to a printer that includes a line head that extends over the entire length of the print medium (or the platen 12) in the main scanning direction and is disposed so as not to be movable in the ejection region B2.

The pipe 61, the pump 62, the valve 63, the filter 64, and the connection portion 65 may be omitted. That is, the treatment liquid tank 9 may be configured not to be connectable to the external tank 70. The treatment liquid tank 9 may not be connected to the external tank 70. Instead of the pipe 61, a gutter (“supply passage” of the present disclosure) configured to supply the treatment liquid to the treatment liquid tank 9 from the outside of the housing 8 may be disposed in the housing 8. In this case, the treatment liquid may be poured onto the gutter from the outside of the housing 8, and the treatment liquid may be supplied to the treatment liquid tank 9. The connection portion 65 may have any configuration as long as the connection portion 65 is connectable to the pipe 71 of the external tank 70. The connection portion 65 may be disposed at an outer surface other than the right side surface 8C of the housing 8. A pump for supplying the treatment liquid in the external tank 70 to the treatment liquid tank 9 may be disposed near the external tank 70. In this case, the pump 62 in the housing 8 may be omitted.

The pump 62 and the filter 64 may be farther from the outside of the housing 8 than the treatment liquid tank 9 is. The pipe 66 as the discharge passage may be omitted. The door 8B1 facing the treatment liquid tank 9 may be omitted. The housing 8 may not have the protruding portion 8B. Each of the ink supplying portion 10A and the treatment liquid supplying portion 9A may be a supply port without the lid 10A1 and the lid 9A1, respectively. The supplying portions 9A and 10A may have any configuration as long as the liquid is supplied.

In the controller 80 in the above-described embodiment, a microcomputer, an ASIC (Application Specific Integrated Circuits), an FPGA (Field Programmable Gate Array), and so on may be used as a processor instead of the CPU 81. The main processing may be performed by a plurality of processors in a distributed manner. The non-transitory storage medium such as the ROM 82 or the flash memory 84 may be any storage medium as long as the medium keeps information regardless of a period of time in which the information is stored. The non-transitory storage medium may not include a transitory storage medium (for example, a transmission signal). The control program may be, for example, downloaded from a server connected to a network (not shown) (that is, transmitted as a transmission signal) and stored in the ROM 82 or the flash memory 84. In this case, the control program may be stored in a non-transitory storage medium such as an HDD in the server.

In the above-described embodiment and modifications, the volatile component of the treatment liquid contains an organic acid, but the present disclosure is not limited to this example. That is, the volatile component of the treatment liquid may include a component that is other than an organic acid and that reacts with the ink in the nozzle to cause aggregation or discoloration. The treatment liquid may not contain a volatile component such as an organic acid.

What is claimed is:

1. A printer comprising:
a housing;
a head disposed in the housing, the head being configured to eject ink onto a print medium;
an ejection device configured to eject a treatment liquid onto the print medium, the treatment liquid forming an undercoat for ink or an overcoat for ink; and
a treatment liquid tank communicating with the ejection device and configured to store the treatment liquid to be supplied to the ejection device,
the treatment liquid tank being disposed in the housing.

2. The printer according to claim 1, wherein the treatment liquid tank is located lower than the head.

3. The printer according to claim 1, further comprising:
a platen movable in a particular direction crossing a vertical direction between an inside and an outside of the housing, the platen being configured to support the print medium,
wherein the treatment liquid tank is located lower than the platen.

4. The printer according to claim 1, further comprising:
a supply passage disposed in the housing, the supply passage communicating an outside of the housing with the treatment liquid tank, the supply passage being configured to supply the treatment liquid from the outside of the housing to the treatment liquid tank.

5. The printer according to claim 4, further comprising:
a connection portion disposed at an outer surface of the housing, the connection portion being connectable to an external tank in which treatment liquid is stored,
wherein one end of the supply passage is connected to the treatment liquid tank; and
wherein another end of the supply passage is connected to the connection portion.

6. The printer according to claim 5, further comprising:
a pump disposed in the housing, the pump being configured to supply the treatment liquid in the external tank connected to the connection portion to the treatment liquid tank via the supply passage.

7. The printer according to claim 6, wherein the pump is closer to the outer surface of the housing than the treatment liquid tank is.

8. The printer according to claim 4, further comprising:
a filter disposed at the supply passage,
wherein the filter is closer to the outer surface of the housing than the treatment liquid tank is.

9. The printer according to claim 1, further comprising:
a discharge passage connected to the treatment liquid tank, the discharge passage being configured to discharge the treatment liquid in the treatment liquid tank to an outside of the housing.

10. The printer according to claim 1, wherein the treatment liquid tank comprises a plurality of treatment liquid tanks.

11. The printer according to claim 1, further comprising:
an ink tank communicating with the head and configured to store ink to be supplied to the head,
wherein the ink tank includes an ink supplying portion exposed to an outside of the housing.

12. The printer according to claim 1, wherein the housing includes a door configured to open and close; and
wherein the door faces the treatment liquid tank.

13. The printer according to claim 1, further comprising:
a platen movable in a particular direction crossing a vertical direction between an inside and an outside of the housing, the platen being configured to support the print medium,
wherein the housing has a platen opening through which the platen is movable;
wherein the housing includes a protruding portion located below the platen opening, the protruding portion protruding in the particular direction; and
wherein the housing includes a door facing the treatment liquid tank, the door being disposed at an end of the protruding portion in the particular direction in which the protruding portion protrudes.

14. The printer according to claim 1, further comprising:
a platen;
a motor configured to drive the platen to move in a particular direction crossing a vertical direction; and
a controller,
wherein the head is located farther in a first direction along the particular direction than the ejection device; and
wherein the controller is configured to:
when the ejection device ejects a pretreatment liquid as the treatment liquid onto the print medium, control the motor to drive the platen to move in the first direction; and
when the head ejects ink onto the print medium, control the motor to drive the platen to move in a second direction opposite the first direction.

15. The printer according to claim 14, wherein the head includes a white head configured to eject white ink and a color head configured to eject color ink; and
wherein the white head is located farther in the first direction along the particular direction than the color head.
